(19) United States
(12) Patent Application Publication
(10) Pub. No.: US 2022/0383120 A1
(43) Pub. Date: Dec. 1, 2022

(54) SELF-SUPERVISED CONTRASTIVE LEARNING USING RANDOM FEATURE CORRUPTION

(71) Applicant: Google LLC, Mountain View, CA (US)

(72) Inventors: Dara Bahri, Lafayette, CA (US); Donald Arthur Metzler, JR., Marina del Rey, CA (US); Hanxi Heinrich Jiang, Miami Beach, FL (US); Yi Tay, Santa Clara, CA (US)

(21) Appl. No.: 17/827,448

(22) Filed: May 27, 2022

Related U.S. Application Data
(60) Provisional application No. 63/194,899, filed on May 28, 2021.

(51) Int. Cl. G06N 3/08; G06K 9/62

(52) U.S. Cl. CPC G06N 3/08; G06K 9/6259; G06K 9/6262

(57) ABSTRACT

Methods, systems, and apparatus, including computer programs encoded on computer storage media, for training a neural network having a plurality of network parameters. One of the methods includes obtaining an unlabeled training input from a set of unlabeled training data; processing the unlabeled training input to generate a first embedding; generating a corrupted version of the unlabeled training input, comprising determining a proper subset of the feature dimensions and, for each feature dimension that is in the proper subset of feature dimensions, applying a corruption to the respective feature in the feature dimension using one or more feature values sampled from a marginal distribution of the feature dimension as specified in the set of unlabeled training data; processing the corrupted version of the unlabeled training input to generate a second embedding; and determining an update to the current values of the plurality of network parameters.

### CROSS-REFERENCE TO RELATED APPLICATION

This application claims the benefit of the filing date of U.S. Application No. 63/194,899, filed on May 28, 2021. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that implements and trains a neural network that can perform a machine learning task on one or more received inputs. In particular, the neural network is trained using a two-stage process: a pre-training stage and a fine-tuning stage. The pre-training stage of the neural network makes use of a self-supervised contrastive learning scheme.

The subject matter described in this specification can be implemented in particular embodiments so as to realize one or more of the following advantages.

The system as described in this specification pre-trains a neural network to generate task-agnostic representations that may later be useful in a specific downstream task by processing a pair of network inputs which need not be labeled. In particular, the pair of network inputs includes an unlabeled training input, e.g., an image, a video, or a text sequence, and a corrupted copy of the unlabeled training input that is automatically generated by the system by randomizing the feature values of a random set of features of the unlabeled training input. Unlike existing self-supervised learning techniques which are typically highly specific to data from a narrow band of technical domains such as computer vision or natural language processing, the marginal sampling corruption technique adopted by the system is universally applicable to data in different formats or different types or both across a variety of technical domains.

Further, the pre-trained neural network can then be used to effectively adapt to a specific machine learning task using orders of magnitude less data than was used to pre-train the network. For example, while pre-training the network may utilize billions of unlabeled training inputs, adapting the network for a specific task may require merely a few thousand labeled training inputs. Because fewer, sometimes orders of magnitude fewer, labeled training inputs than existing approaches are needed to train the network for the specific task, the system can thus make more efficient use of computational resources, e.g., memory, wall clock time, or both during fine-tuning. The system can also train the neural network at lower human labor cost associated with data labeling, while still ensuring a competitive performance of the trained neural network on a range of tasks that match or even exceed the state-of-the-art while additionally being generalizable and easily adaptable to new tasks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network system during a pre-training stage.

FIG. 1B shows the example neural network system during a fine-tuning stage.

FIG. 2 is a flow diagram of an example process for pre-training a neural network using a self-supervised contrastive learning scheme.

FIG. 3 is a flow diagram of an example process for fine-tuning a neural network on a machine learning task.

FIGS. 4A-B are example illustrations of pre-training and fine-tuning a neural network, respectively.

Like reference numbers and designations in the various drawings indicate like elements.

### DETAILED DESCRIPTION

This specification describes a system implemented as computer programs on one or more computers in one or more locations that implements and trains a neural network that can perform a machine learning task on one or more received inputs. Depending on the task, the neural network can be configured to receive any kind of digital data input and to process the received input in accordance with current parameter values of the neural network to generate one or more outputs based on the input.

In some cases, the input to the neural network includes tabular data. Tabular data refers to digital data or information that is arranged in rows and columns or in the form of a matrix of cells. Tabular data refers to the arrangement of the information and not to the specific type of data found at a given location in the column, row or cell. Nor does tabular data refer to the actual data that may be represented by the tabular data. For example, each given location may have a numeric value representing a pixel value (in the case where the tabular data represents image data) or may alternatively have a numeric value representing a letter, a word, a phrase, or a sentence (in the case where the tabular data represents text data).

In some cases, the output of the neural network includes a classification output of any kind. The classification can be, for example, a type, a class, a group, a category, or a measurement.

For example, the neural network can be configured to perform an automatic pattern recognition task in context of a manufacturing plant, where the neural network receives input data that includes multiple features describing a fault, e.g., the location, the size, or the like, of a manufactured product, and processes the input data to generate a classification output that specifies a type of the fault, e.g., scratch, stain, dirtiness, bump, or the like. In this example, the input may be arranged in a tabular data format having rows or columns which correspond to the multiple features describing the fault of the manufactured product, e.g., may have multiple columns where each column has a respective feature describing the fault.

As another example, the neural network can be configured to process input data that describes the physical characteristics of a leaf sample of a plant, e.g., the shape, the texture, the margin, and the like, to generate a classification output that specifies a species of the plant.

Examples of labeled datasets for such tasks and other similar classification tasks can be found in the University of California-Irvine Machine Learning Repository (UCI repository) and Open Media Library (OpenML).

In further examples, the task can be a computer vision task, where the input is an image or a point cloud and the output is a computer vision output for the image or point cloud. For example, the neural network can be configured to perform an image processing task, e.g., to receive an input comprising image data which includes a plurality of pixels. The image data may for example comprise one or more images or features that have been extracted from one or more images. The neural network can be configured to process the image data to generate an output for the image processing task.

For example, if the task is image classification, the outputs generated by the neural network for a given image may be scores for each of a set of object categories, with each score representing an estimated likelihood that the image contains an image of an object belonging to the category.

As another example, if the task is object detection, the outputs generated by the neural network for a given image may be one or more bounding boxes each associated with respective scores, with each bounding box representing an estimated location in the image and the respective score representing an estimated likelihood that an object is depicted at the location in the image, i.e., within the bounding box.

As another example, if the task is semantic segmentation, the outputs generated by the neural network for a given image may be labels for each of a plurality of pixels in the image, with each pixel being labeled as belonging to one of a set of object categories. Alternatively, the outputs can be, for each of the plurality of pixels, a set of scores that includes a respective score for each of the set of object categories that represents the likelihood that the pixel belongs to an object from the object category.

As another example, if the inputs to the neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

For example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

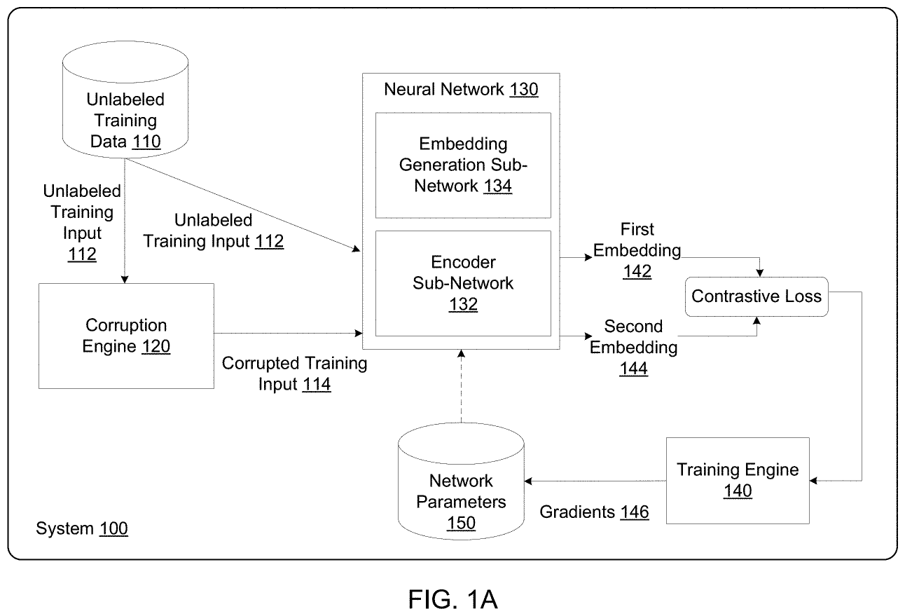

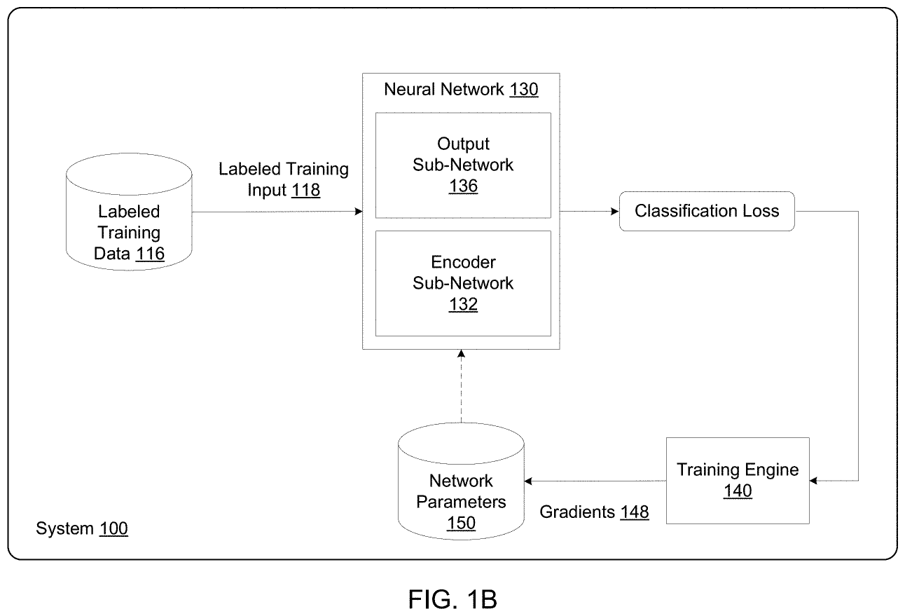

FIG. 1A shows an example neural network system 100 during a pre-training stage. The neural network system 100 is an example of a system implemented as computer programs on one or more computers in one or more locations, in which the systems, components, and techniques described below can be implemented.

The neural network system 100 includes a corruption engine 120, a neural network 130, and a training engine 140. The neural network 130 is configured to receive an input and generate an output based on the received input and on values of the network parameters 150 of the neural network 130.

In general, the neural network 130 can have any appropriate neural network architecture that enables it to perform the machine learning tasks mentioned above. In the example of FIG. 1A, the neural network 130 includes an encoder sub-network 132 and an embedding generation sub-network 134. A sub-network of a neural network refers to a group of one or more neural network layers in the neural network. When the inputs include text data, the encoder sub-network 132 can be a fully-connected sub-network, i.e., that includes one or more fully-connected neural network layers and, in some implementations, one or more nonlinear activation layers, e.g., ReLU activation layers, that is configured to process the input to generate an encoder network output. When the inputs include image data, the encoder sub-network 132 can additionally or alternatively include one or more convolutional neural network layers. The embedding generation sub-network 134 can be similarly configured as a fully-connected sub-network, can then process the encoder network output generated by the encoder sub-network 132 to generate an embedding for the input, which is typically a numeric representation that has a fixed dimensionality.

As another example, the neural network 130 can be an attention neural network that includes one or more attention layers. As used herein an attention layer is a neural network layer that includes an attention mechanism, e.g., a multi-head self-attention mechanism. Examples of configurations of attention neural networks and the specifics of the other components of attention neural networks, e.g., embedding layers that embed inputs to the neural network or the feed-forward layers within the layers of the attention network, are described in more detail in Vaswani, et al, Attention Is All You Need, arXiv: 1706.03762, and Raffel, et al, Exploring the Limits of Transfer Learning with a Unified Text-to-Text Transformer, arXiv: 1910.10683, the entire contents of which are hereby incorporated by reference herein in their entirety.

In some cases, the architecture of the neural network 130 remains identical during both pre-training and fine-tuning stages while in other cases, the neural network 130 can have different architectures during the two stages. In the latter cases, the neural network 130 can have a common backbone sub-network (e.g., the encoder sub-network 132 of FIG. 1A) during both pre-training stage and fine-tuning stage, and can have a different auxiliary sub-network that is used at each stage (e.g., the embedding generation sub-network 134 that is used during the pre-training stage or the output sub-network 136 of FIG. 1B that is used during the fine-tuning stage).

In the example of FIG. 1A, the neural network 130 includes the embedding generation sub-network 134 which is only used to assist in the training of the encoder sub-network 132 during the pre-training stage. In other words, once the pre-training has completed, i.e., during either fine-tuning stage or deployment, the embedding generation sub-network 134 will no longer be included as part of the neural network 130.

The training engine 140 in the system 100 trains the neural network 130 on the unlabeled training data 110 to determine learned values of the network parameters 150 from initial values of the network parameters using an iterative training process. At each iteration of the training process, the training engine 140 determines a parameter value update to the current values of the network parameters 150 (including the parameters of the encoder sub-network 132 and those of the embedding generation sub-network 134) and then applies the update to the current values of the network parameters 150.

In particular, to effectively determine trained values of the parameters 150 of the neural network 130 by making use of unlabeled training data 110 which is relatively more easily obtainable in massive volumes across a wide range of machine learning tasks, i.e., compared with labeled (e.g., human annotated) training data, the training engine 140, working in tandem with the corruption engine 120, trains the neural network 130 by using a self-supervised contrastive learning technique.

An unlabeled training input 112 from the unlabeled training data 110 refers to a training input for which information about a known, ground truth output, e.g., a ground truth classification of the training input, that should be generated by the neural network 130 is not used by the system 100. The unlabeled training input 112 includes a plurality of features representing any kind of digital data. In some examples, each feature can represent one of a set of attributes or characteristics describing a subject of a classification task. In other examples, each feature can represent a different intensity value of a corresponding channel of a corresponding pixel, a different text token in a sequence of text, a different amplitude value in audio data, a different point in a point cloud, or the like for any appropriate task.

During the pre-training stage, for each unlabeled training input 112, the corruption engine 120 processes the unlabeled training input to generate a corrupted version of the unlabeled training input (“corrupted training input”) 114 by corrupting, i.e., modifying, a subset of features contained in the original, unlabeled training input. In particular, the corruption engine 120 is configured to generate the corrupted training input 114 using a marginal sampling corruption technique.

A number of contrastive learning and associated corruption techniques have been successful in vision domain (e.g., image-based corruption techniques such as random cropping, color distortion, and blurring) and natural language domain (e.g., text-based corruption techniques such as token masking, deletion, and infilling). Yet one type of data that appears to be lacking behind, despite being one of the most common data types in computing, is tabular data.

Specifically, in tabular data format, the unlabeled training input 112 may have a respective feature in each of a plurality of feature dimensions, e.g., in each of a plurality of rows or columns or both. Each respective feature may have a feature value, which is typically a numerical value, that represents the feature. Each respective feature may either be a numerical feature or may alternatively be a discrete feature. In other words, the unlabeled training input 112 may include some features that are numerical features and some features that are discrete features. Numerical features are features that have numerical values that may be any value within some range, while discrete features include binary features and other features that can only take one of a small number of possible values, e.g., categorical features.

By applying the disclosed marginal sampling corruption technique which is effectively applicable to tabular data, the corruption engine 120 can generate the corrupted training input 114 by first selecting which feature dimensions to corrupt and, for each selected feature dimension, applying a corruption to the feature value in the feature dimension based on the empirical marginal distribution of the feature value in the training input.

For each unlabeled training input 112, the neural network 130 processes the original, uncorrupted version of the unlabeled training input 112 to generate a first embedding 142. Moreover, the neural network 130 processes the corrupted training input 114 that has been generated by the corruption engine 120 from the unlabeled training input 112 to generate a second embedding 144. That is, the first and second embeddings 144 are generated by the same neural network (having the same architecture and the same parameter values) for two different versions—the original version and the corrupted version—of the same training input.

The training engine 140 can then determine the parameter value updates by backpropagating gradients 146 of a contrastive loss function, which measures a difference between the first and second embeddings 142 and 144, through the parameters of the embedding generation sub-network 134 and the encoder sub-network 132. For example, the contrastive loss function can be a noise contrastive estimation (NCE) loss function, e.g., an InfoNCE loss function.

FIG. 1B shows the example neural network system 100 during a fine-tuning stage.

After the pre-training, the training engine 120 of system 100 then makes use of labeled training data 116 that includes a plurality of labeled training inputs 118 to adapt the pre-trained neural network 130 to a downstream task, which can be any of the machine learning task mentioned above.

In some cases, all of the neural network 130 that has been pre-trained is subsequently fine-tuned, while in other cases, only a part of the neural network 130 is subsequently fine-tuned. In the example of FIG. 1B, in addition to having the encoder sub-network 132, the neural network 130 includes, in place of the embedding generation sub-network 134, an output sub-network 136 which can be configured to process the encoder network output generated by the encoder sub-network 132 to generate an output for the downstream task. The embedding generation sub-network 134 is no longer needed and is thus not fine-tuned further.

A labeled training input 118 from the labeled training data 116 refers to a training input for which information about a known, ground truth output, e.g., a ground truth classification of the training input, that should be generated by the neural network 130 is defined or otherwise specified by the training input and is thus available to the system 100.

Generally the data used for the fine-tuning stage can be orders of magnitude smaller than data used for the pre-training stage. In some implementations, the unlabeled training data 110 includes millions of unlabeled training inputs, while the labeled training data 132 includes merely a few thousand labeled training inputs. In addition, the self-supervised contrastive learning technique as well as the corruption processing steps are no longer required. Rather, a more conventional supervised learning technique may be used during the fine-tuning stage.

Adapting the pre-trained neural network 130 to the downstream task involves adjusting the learned values of some or all of the network parameters 150. In the example of FIG. 1B, during the fine-tuning stage, the parameters of the encoder sub-network 132 and the output sub-network 136, and not those of the embedding generation sub-network 134, which is no longer included as part of the neural network 130, are adjusted. The training engine 140 can determine the parameter value updates by backpropagating gradients 148 of a suitable objective function for the downstream task through the parameters of the output sub-network 136 and the encoder sub-network 132. For example, the objective function can be a cross-entropy loss function that measures the quality of a classification output generated by the neural network 130 by processing a training input, i.e., relative to the ground truth classification associated with the training input.

Once the two-stage process has completed, the system 100 can provide data specifying the trained neural network, e.g., data specifying the architecture of the neural network (which may be the same as the architecture used during the fine-tuning and rather than the pre-training stage) and the trained values of the network parameters 150 of the neural network, to another system, e.g., a server, for use in processing new inputs. Instead of or in addition to providing the data specifying the trained neural network, the system 100 can use the trained neural network to process new inputs and generate respective outputs.

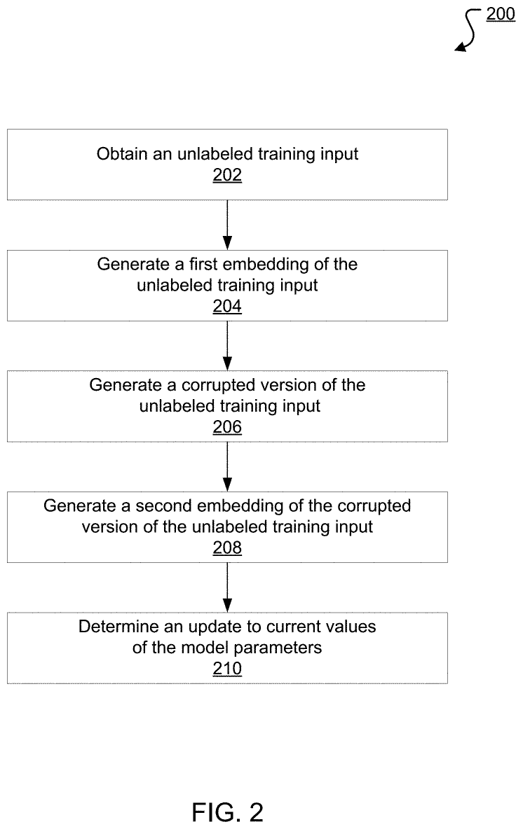

FIG. 2 is a flow diagram of an example process 200 for pre-training a neural network using a self-supervised contrastive learning scheme. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system obtains an unlabeled training input from a set of unlabeled training data (step 202). The set of unlabeled training data can be obtained through random sampling from the unlabeled training data used to pre-train the neural network. The set of unlabeled training data can include a fixed number of unlabeled training inputs, e.g., 64, 128, or 256. The system generally performs one iteration of steps 202-208 on each unlabeled training input included in the set of unlabeled training data.

The unlabeled training input can have a tabular data format. The unlabeled training input can have a respective feature in each of a plurality of feature dimensions. Each respective feature may have a feature value, which is typically a numerical value, that represents the feature. For example, the unlabeled training input can include data describing a matrix that has the features of the unlabeled training input arranged as matrix elements in rows or columns of the matrix, where each row or column corresponds to a specific feature dimension. In other similar examples, the unlabeled training input can include data describing a vector, a table, an array, or the like.

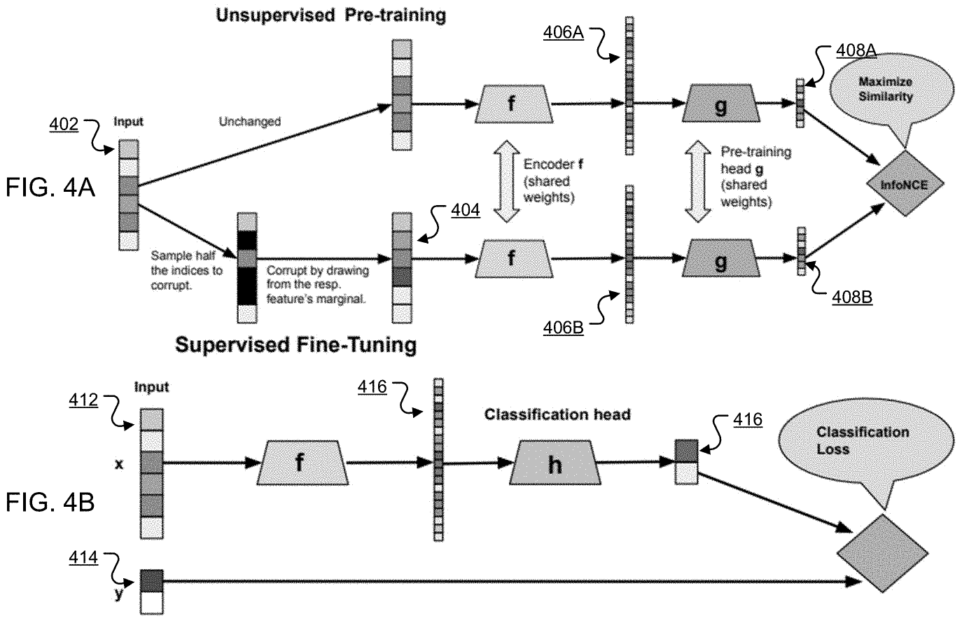

FIG. 4A is an example illustration of pre-training a neural network. As illustrated, an unlabeled training input 402 is a 6-dimensional vector, i.e., a vector with six feature dimensions. The unlabeled training input 402 has a respective feature in each of the six feature dimensions.

The system processes, using the neural network and in accordance with current values of the plurality of network parameters, the unlabeled training input to generate a first embedding of the unlabeled training input (step 204). The embedding can be a numeric representation that has a fixed dimensionality.

In the example of FIG. 4A, the neural network includes an encoder sub-network and an embedding generation sub-network. In this example, the system can first process the unlabeled training input 402 in accordance with current values of the encoder network parameters (denoted by f) to generate an encoder network output (the embedding 406A), and then process the encoder network output in accordance with current values of the embedding generation network parameters (denoted by g) to generate the first embedding 408A of the unlabeled training input.

The system generates a corrupted version of the unlabeled training input (step 206).

Generating the corrupted version of the unlabeled training input can include the operations of determining a proper subset of the feature dimensions and, for each feature dimension that is in the proper subset of feature dimensions, applying a corruption to the respective feature in the feature dimension using one or more feature values sampled from a marginal distribution of the feature dimension as specified in the set of unlabeled training data. Applying the corruption can include replacing the feature in each feature dimension in the proper subset with the one or more sampled feature values.

In some implementations, the system can determine the proper subset of the feature dimensions by sampling, with uniform randomness, the proper subset of feature dimensions from the plurality of feature dimensions. In some implementations, the system can determine the proper subset of feature dimensions in accordance with a predetermined corruption rate which specifies a total number of feature dimensions to be selected. For example, the predetermined corruption rate c can be a percentage value (e.g., 20%, 30%, 50%, or the like) defined with respect to the total number M of feature dimensions included in the unlabeled training input. In this example, the system can sample a total number of c×M feature dimensions, and then apply a corruption to the respective feature in each sampled feature dimension.

In the example of FIG. 4A, the system samples half of the six feature dimensions of the unlabeled training input 402, and then replaces the original feature value in each sampled feature dimension with a feature value sampled from the empirical marginal distribution of the feature dimension.

In particular, the marginal distribution of a feature dimension can be defined as a uniform distribution over all values that the features in the feature dimension across the set of unlabeled training data have taken on. In other words, to determine the one or more replacement feature values for each feature dimension in the proper subset, the system can sample from the uniform distribution over all feature values that appear in the feature dimension at least a threshold amount of times across the set of unlabeled training data. For example, the threshold is one, although in other examples the threshold may be raised.

Mathematically, let the set of unlabeled training data be X⊆ [symbol] ^{M}, where M is the number of feature dimensions, [symbol] be the uniform distribution over Xⱼ={xⱼ:x∈X}, where xⱼ denotes the j-th feature dimension of x, for each unlabeled training input x⊆X, the system can uniformly sample a proper subset of feature dimensions [symbol] from the plurality of feature dimensions {1, . . . , M} of size q and generate the corrupted version of the unlabeled training input \tilde{x}∈ [symbol] ^{M} as follows: \tilde{x}ⱼ=xⱼ if j∉ [symbol] , otherwise \tilde{x}ⱼ=v, where v˜ [symbol] .

The system processes, using the neural network and in accordance with the current values of the plurality of network parameters, the corrupted version of the unlabeled training input to generate a second embedding of the corrupted version of the unlabeled training input (step 208). In other words, the system uses the same neural network (having the same neural network architecture and the same parameter values) that has been used to generate the first embedding of the unlabeled training input to generate the second embedding of the same unlabeled training input by processing the corrupted version of the unlabeled training input.

As illustrated, the system first processes the corrupted version 404 of the unlabeled training input in accordance with current values of the encoder network parameters (denoted by f) to generate an encoder network output (the embedding 406B), and then processes the encoder network output in accordance with current values of the embedding generation network parameters (denoted by g) to generate the second embedding 408B of the corrupted version of the unlabeled training input.

The system computes, e.g., through backpropagation, a gradient with respect to the plurality of network parameters of a contrastive learning loss function (step 210). The contrastive learning loss function evaluates, for each unlabeled training input in the set of unlabeled training data, a difference between the first embedding of the unlabeled training input and the second embedding of the corrupted version of the unlabeled training input. In addition, the contrastive learning loss function evaluates, for each unlabeled training input in the set of unlabeled training data, a difference between the first embedding of the unlabeled training input and a corresponding first embedding that has been generated by the neural network for each other unlabeled training input in the set.

The contrastive learning loss function trains the neural network to generate representations that are robust to different versions of the same input by maximizing the similarity between respective embeddings of different versions of the same input (i.e., between the embeddings of a positive training pair), and minimizing the similarity between respective embeddings of those of different inputs (i.e., between the embeddings of a negative training pair). For example, the contrastive learning loss function can be a noise contrastive estimation (NCE) loss function, e.g., an InfoNCE loss function.

The system proceeds to update the current parameter values based on the gradient and by using an appropriate gradient descent optimization technique, e.g., stochastic gradient descent, RMSprop or Adam technique.

The system can repeatedly perform the process 200 until a pre-training termination criterion is satisfied, e.g., after the process 200 have been performed a predetermined number of times, after the gradient of the contrastive learning function has converged to a specified value, or after some early stopping criteria are satisfied.

After determining that the pre-training termination criterion is satisfied, the system can proceed to adapt the neural network for a specific machine learning task. In some cases, all of the pre-trained neural network is subsequently fine-tuned while in other cases, only a part of the pre-trained neural network is subsequently fine-tuned. In the latter cases, the system can fine-tune the encoder sub-network, including adjusting the learned values of the encoder network parameters, by retraining the encoder sub-network in tandem with an output sub-network with respect to labeled training data. The labeled training data include training inputs that are dedicated to the specific machine learning task and that are each associated with a corresponding ground truth output.

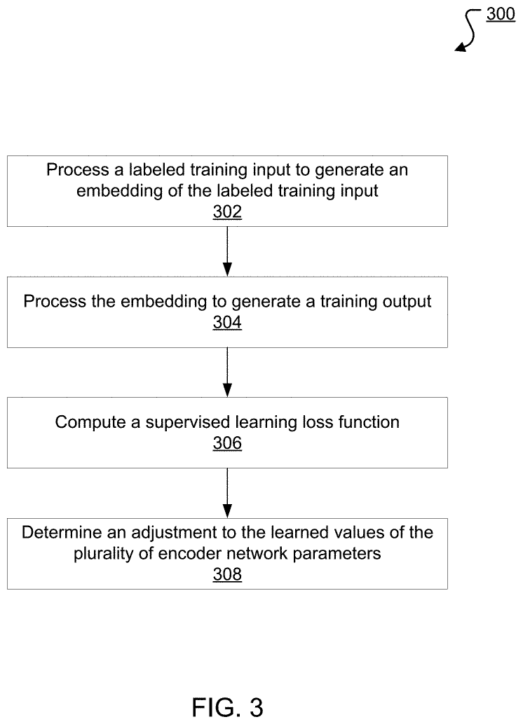

FIG. 3 is a flow diagram of an example process 300 for fine-tuning a neural network on a machine learning task. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system processes, using the encoder sub-network and in accordance with the learned values of the plurality of encoder network parameters, a labeled training input in a set of one or more labeled training inputs to generate an embedding of the labeled training input (step 302). For example, the set of labeled training inputs is sampled from a larger labeled training dataset.

The system processes, using an output sub-network and in accordance with current values of a plurality of output network parameters, the embedding to generate a training output for each labeled training input in the set of labeled training inputs (step 304).

FIG. 4B is an example illustration of fine-tuning a neural network. As illustrated, the system can first process the labeled training input 412 in accordance with current values of the encoder network parameters (denoted by f) to generate an encoder network output (the embedding 416), and then process the encoder network output in accordance with current values of the output network parameters (denoted by h) to generate the training output 416.

The system computes a supervised learning loss function (step 306). The supervised learning loss function evaluates, for each labeled training input in the set of labeled training inputs, a difference between the training output and a ground truth output associated with the labeled training input. The system also computes, e.g., through backpropagation, a gradient of the supervised learning loss function with respect to the plurality of encoder network parameters and to the plurality of output network parameters.

In the example of FIG. 4B, the specific machine learning task is a classification task, and the supervised learning loss function can be a classification loss function, e.g., a cross-entropy loss function, that evaluates a difference between the training output 416 and a ground truth output 414 associated with the labeled training input 412.

The system then proceeds to update the current values of encoder network parameters and the output network parameters (step 308) based on the gradient and by using an appropriate gradient descent optimization technique, e.g., stochastic gradient descent, RMSprop or Adam technique.

In this way, the parameter values learned during pre-training process are adjusted so that they are adapted to the specific machine learning task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of training a neural network having a plurality of network parameters, the method comprising:
obtaining an unlabeled training input from a set of unlabeled training data, the unlabeled training input having a respective feature in each of a plurality of feature dimensions;
processing, using the neural network and in accordance with current values of the plurality of network parameters, the unlabeled training input to generate a first embedding of the unlabeled training input;
generating a corrupted version of the unlabeled training input, comprising
determining a proper subset of the feature dimensions and,
for each feature dimension that is in the proper subset of feature dimensions, applying a corruption to the respective feature in the feature dimension using one or more feature values sampled from a marginal distribution of the feature dimension as specified in the set of unlabeled training data;
processing, using the neural network and in accordance with the current values of the plurality of network parameters, the corrupted version of the unlabeled training input to generate a second embedding of the corrupted version of the unlabeled training input; and
determining, based on computing a gradient with respect to the plurality of network parameters of a contrastive learning loss function that evaluates a difference between the first and second embeddings, an update to the current values of the plurality of network parameters.

2. The method of claim 1, wherein the contrastive learning loss function comprises a noise contrastive estimation (NCE) loss function.

3. The method of claim 2, wherein the NCE loss function comprises an InfoNCE loss function.

4. The method of claim 1, wherein determining the proper subset of feature dimensions comprises sampling the proper subset of feature dimensions from the plurality of feature dimensions with uniform randomness.

5. The method of claim 4, further comprising determining the subset of selected feature dimensions with uniform randomness in accordance with a predetermined corruption rate which specifies a total number of feature dimensions to be selected.

6. The method of claim 1, wherein sampling the one or more feature values from the marginal distribution of the feature dimension as specified in the set of unlabeled training data comprises:
sampling, the one or more feature values from a uniform distribution over the feature values that appear in the feature dimension at least a threshold amount of times across the unlabeled training inputs in the set of unlabeled training data.

7. The method of claim 6, wherein the threshold is one.

8. The method of claim 1, wherein applying the corruption to the feature using the one or more feature values comprises replacing the feature with the one or more feature values.

9. The method of claim 1, wherein the features in at least one feature dimension are numerical features.

10. The method of claim 1, wherein the features in at least one feature dimension are categorical features.

11. The method of claim 1, wherein the features in a first feature dimension are numerical features and the features in a second feature dimension are categorical features.

12. The method of claim 1, wherein the neural network comprises an encoder sub-neural network having a plurality of encoder network parameters and an embedding generation sub-neural network having a plurality of embedding generation network parameters,

13. The method of claim 8, wherein the training further comprises, after training the neural network on the set of unlabeled training data, adapting the sub-encoder neural network for a specific machine learning task including adjusting learned values of the plurality of encoder network parameters using labeled data comprising labeled training inputs.

14. The method of claim 13, wherein adapting the encoder neural network for a specific machine learning task further comprises:
processing, using the encoder sub-neural network and in accordance with the learned values of the plurality of encoder network parameters, a labeled training input to generate an embedding of the labeled training input;
processing, using an output sub-neural network and in accordance with current values of a plurality of output network parameters, the embedding to generate a training output;
computing a supervised learning loss function evaluating a difference between the training output and a ground truth output associated with the labeled training input; and
determining, based on computing a gradient of the supervised learning loss function with respect to the plurality of encoder network parameters and to the plurality of output network parameters, an adjustment to the learned values of the plurality of encoder network parameters.

15. The method of claim 14, wherein the specific machine learning task comprises a classification task, and wherein the supervised learning loss function comprises a cross-entropy loss function.

16. The method of claim 13, further comprising providing the learned values of the encoder network parameters for use in performing the specific machine learning task.

17. A system comprising one or more computers and one or more storage devices storing instructions that are operable, when executed by the one or more computers, to cause the one or more computers to perform operations of training a neural network having a plurality of network parameters, wherein the operations comprise:
obtaining an unlabeled training input from a set of unlabeled training data, the unlabeled training input having a respective feature in each of a plurality of feature dimensions;
processing, using the neural network and in accordance with current values of the plurality of network parameters, the unlabeled training input to generate a first embedding of the unlabeled training input;
generating a corrupted version of the unlabeled training input, comprising
determining a proper subset of the feature dimensions and,
for each feature dimension that is in the proper subset of feature dimensions, applying a corruption to the respective feature in the feature dimension using one or more feature values sampled from a marginal distribution of the feature dimension as specified in the set of unlabeled training data;
processing, using the neural network and in accordance with the current values of the plurality of network parameters, the corrupted version of the unlabeled training input to generate a second embedding of the corrupted version of the unlabeled training input; and
determining, based on computing a gradient with respect to the plurality of network parameters of a contrastive learning loss function that evaluates a difference between the first and second embeddings, an update to the current values of the plurality of network parameters.

18. The system of claim 17, wherein the contrastive learning loss function comprises a noise contrastive estimation (NCE) loss function.

19. The system of claim 17, wherein sampling the one or more feature values from the marginal distribution of the feature dimension as specified in the set of unlabeled training data comprises:
sampling, the one or more feature values from a uniform distribution over the feature values that appear in the feature dimension at least a threshold amount of times across the unlabeled training inputs in the set of unlabeled training data.

20. A computer storage medium encoded with instructions that, when executed by one or more computers, cause the one or more computers to perform operations of training a neural network having a plurality of network parameters, wherein the operations comprise:
obtaining an unlabeled training input from a set of unlabeled training data, the unlabeled training input having a respective feature in each of a plurality of feature dimensions;
processing, using the neural network and in accordance with current values of the plurality of network parameters, the unlabeled training input to generate a first embedding of the unlabeled training input;
generating a corrupted version of the unlabeled training input, comprising
determining a proper subset of the feature dimensions and,
for each feature dimension that is in the proper subset of feature dimensions, applying a corruption to the respective feature in the feature dimension using one or more feature values sampled from a marginal distribution of the feature dimension as specified in the set of unlabeled training data;
processing, using the neural network and in accordance with the current values of the plurality of network parameters, the corrupted version of the unlabeled training input to generate a second embedding of the corrupted version of the unlabeled training input; and
determining, based on computing a gradient with respect to the plurality of network parameters of a contrastive learning loss function that evaluates a difference between the first and second embeddings, an update to the current values of the plurality of network parameters.
